(19) United States
(12) Patent Application Publication
(10) Pub. No.: US 2008/0291274 A1
(43) Pub. Date: Nov. 27, 2008

(54) Method for Operating at Least One Camera

(76) Inventors: Marcel Merkel, Hildesheim (DE); Stefan Mueeler-Schneiders, Duesseldorf (DE)

Correspondence Address: MICHAEL J. STRIKER, 103 EAST NECK ROAD, HUNTINGTON, NY, 11743, US

(21) Appl. No.: 12/096,045

(22) PCT Filed: Jul. 16, 2007
(86) PCT No.: PCT/EP07/57323

§ 371 Date: Jun. 4, 2008

(30) Foreign Application Priority Data
Sep. 8, 2006 (DE) 10200604042318.6

(51) Int. Cl. H04N 7/18

(52) U.S. Cl. 348/143; 348/E07.085

(57) ABSTRACT

The invention relates to a method for operating at least one camera (2), in which a position of the at least one camera (2) is determined and information about a scene which can be observed on the basis of the position is made available for image processing.

The invention relates to a method for operating at least one camera and to a camera, a camera assembly, a computer program, and a computer program product.

### PRIOR ART

In response to the increasing need for security, more and more surveillance cameras are being installed in public places and in the field of object protection. Often, this surveillance camera is followed downstream by an image processor (BV), which is embodied for automatically evaluating images from the surveillance camera. The image processor as a rule comprises modules which perform object detection, classification of the objects, and object tracking. However, such modules for image processing have only little capability of adapting for image processing algorithms.

International Patent Disclosure WO 02/13513 A1 shows a method and an arrangement for external calibration of a camera via a graphical user interface. A representation of an area in which the camera is used as well as calibration information on calibration points of the area are displayed by the graphical user interface. The calibration information on the calibration points is input via the graphical user interface by means of commands that identify a position of the camera. External calibration, including camera positioning, is calculated on the basis of the calibration information and the calibration points.

### DISCLOSURE OF THE INVENTION

The invention relates to a method for operating at least one camera, in which a position of the at least one camera is determined, and for image processing, information about a scene to be observed from the position is furnished.

In its embodiment, it is provided that the information is furnished from the Internet, and relevant web pages that take into account the position of the scene and weather that is either predicted and/or occurring are evaluated. Particularly based on the furnished information, it is also possible to take into account the likelihood with which objects, and which ones of those objects, are to be observed in the scene by the camera. If the at least one camera is observing a street, then as a rule vehicles and pedestrians are expected as objects to be observed. If the at least one camera is observing a scene in a building, then pedestrians, but not vehicles, are to be expected as objects to be observed.

With the method, the at least one camera can also be registered inside a camera assembly that includes a plurality of cameras. With such registration, the position of a plurality of cameras relative to one another can be determined. Thus image processing of the cameras can be adapted to one another, so that in particular by means of an arrangement which is embodied for performing the method of the invention, the cameras are controlled and adjusted in such a way that an especially large-area scenario can for instance be observed.

Since typically the cameras observe a plurality of different scenes, a complete scenario to be observed by the cameras of the camera assembly which includes all the scenes can be taken into account based on the registration. Thus it is possible for instance for an object that is moving through a plurality of scenes to be observed continuously.

Taking into account at least one of the aspects mentioned above, a scene model and thus a model concept of the scene to be observed by one camera and a scenario that is observed by a plurality of cameras can be furnished.

The arrangement according to the invention for a camera assembly having at least one camera has at least one module and is embodied for determining a position of the at least one camera and furnishing information about a scene to be observed from that position.

It is provided that the at least one module is embodied as a GPS receiver and/or as an electronic compass. Thus information on the satellite-based Global Positioning System (GPS) can be furnished. The information on the position can be furnished in general by satellite navigation, typically a so-called Global Navigation Satellite System (GNSS), or also the European satellite navigation system Galileo. However, it is also conceivable to use other suitable sensor devices for navigation and/or position determination or to use WLAN. The at least one module is furthermore embodied for furnishing and evaluating information from the Internet or World Wide Web (WWW). With the arrangement or the at least one module of the arrangement, various steps of the method according to the invention can be performed.

With the arrangement, the at least one camera, which is either location-specific and in particular movable, or not location-specific, can be controlled. This for instance includes controlling the video and/or photographic parameters, such as segmentation strategy, exposure time, color correction, and the like, for adjusting the camera, taking into account the weather and the amount of light or darkness, which depends on the time of day. If a position, in particular an orientation, of the at least one camera can be manipulated, for instance electromechanically, then this is likewise possible by means of the arrangement. Thus a plurality of cameras can be adapted to one another with regard to their position and their orientation, in such a way that overlaps of individual scenes that supplement one another are used or alternatively are avoided.

The camera assembly of the invention has at least one camera and at least one module, and the at least one module is embodied for ascertaining a position of the at least one camera and furnishing information about a scene to be observed from that position.

Hence this camera assembly can also have at least one arrangement according to the invention and be suitable for performing steps of the method of the invention.

The invention furthermore relates to a computer program having program code means, for performing an explained method, when the computer program is executed on a computer or a corresponding computation unit, in particular in an arrangement according to the invention.

The computer program product according to the invention having program code means that are stored in memory on a computer-readable data carrier, for performing all the steps of a method according to the invention, when the computer program is executed on a computer or a corresponding computation unit, in particular an arrangement as described.

With the invention, the installed camera or surveillance camera is provided with a “concept of a surrounding area” in which it is installed and hence hung up or set up. This is done in terms of embodiment by using the following modules: a GPS receiver, an electronic compass, a module for furnishing access to the Internet, which is done for instance by means of WLAN or with a landline, and a module for evaluating important web pages, such as Google Earth, in which regional and city maps or aerial views are furnished. With the invention, the camera is provided with information on the observed scene or the observed surroundings by means of ascertaining the position and by the comparison of the information with the knowledge on the surroundings that is taken from the Internet. From the positional determination by means of GPS and the compass, the position and the viewing direction of the camera can be ascertained relative to the surroundings. This position can be compared with map material from the Internet, such as Google Maps or from the geographical data server for the Ruhr region.

Thus the camera is imparted information about the observed scene, and it can be discovered whether the camera is observing a wooded area, a street scene, or a residential district with houses. Consequently, it can be ascertained what objects are the most likely to turn up in the scene. In a wooded area, for instance, animals are highly likely to be observed, while conversely it is unlikely for motor vehicles to be detected.

In a further feature, the current weather and weather predictions can be taken from the Internet. This makes it possible to use special modules in the image processing. Such modules are for instance a shade detector, which can be used in sunny weather, and a light-detecting module, which is used in the event of precipitation, or in other words rain or snow, or corresponding weather. Information on the wind direction and wind intensity can also be taken from a weather page on the Internet. This information can be used for predicting movements of leaves and branches.

By determining the position via GPS and compass, the course of the sun can also be predicted, so that the image processing can adjust to the location of the sun and in general to the overall amount of daylight.

Based on the knowledge of the scene, such as knowledge about the position of the streets and houses, activity patterns can be predicted. The registration of cameras of the camera assembly or a camera network is possible in the implementation of the invention. As a consequence of the registration, the location of a plurality of cameras relative to one another is known. It is thus possible to track objects over a plurality of cameras simultaneously over a relatively large area.

Since in future more and more areas will also be provided with 3D data, and the location and size of buildings will be plotted three-dimensionally and to scale in associated 3D maps, the automatic adjustment and hence calibration of cameras will be possible with the aid of these 3D data as furnished information.

For the operator of a large number of cameras, it will be much easier to gain an overview of the installed cameras. Moreover, it can be monitored in a simple way whether all the relevant areas to be observed can be observed by cameras. From the comparison with the map information, it will then typically be learned whether the camera is potentially located in a building.

In all, the use of the proposed method leads to more-robust algorithms and to a model concept or scene model for the observed scene. This model concept of the observed scene can then be verified and refined with the aid of the image processor.

Further advantages and features of the invention will become apparent from the description and the accompanying drawings.

It is understood that the characteristics mentioned above and those to be explained hereinafter are usable not only in the particular combination stated but in other combinations or on their own, without departing from the scope of the present invention.

### BRIEF DESCRIPTION OF THE DRAWINGS

The invention is shown schematically in terms of embodiments in the drawings and will be described in detail below in conjunction with the drawings.

FIG. 1 shows a first embodiment of a camera with an arrangement in a schematic view.

FIG. 2 shows an aerial view and a detail from a city map.

FIG. 3 schematically shows one embodiment of the camera assembly and a second embodiment of an arrangement according to the invention.

### EMBODIMENTS OF THE INVENTION

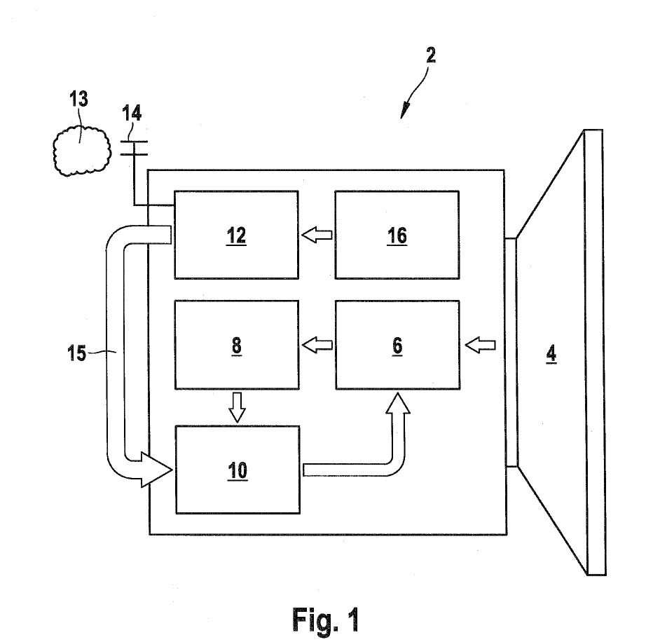

The embodiment of a camera 2 shown schematically in FIG. 1 includes a first module 4 for taking and digitizing images of a scene to be observed by the camera 2. A second module 6 includes a short-term image processor which evaluates images from the camera 2 and detects moving objects. The second module 6 furthermore classifies these objects and carries out tracking. Many pieces of such movement information are transferred to a third module 8 for long-term image processing, and that module learns a scene model, from typical patterns in a fourth module 10. Then, after a learning phase, the scene model contains typical movement trajectories, concealment maps, such as information on the location of the camera in space, and so forth. It is the task of the scene model to improve the achievements of the second module for short-term image processing, in particular with regard to an associated sturdiness of the camera 2. This can be done for instance by forecasting concealments or predicting movements of objects.

As a further information source, the camera has a fifth module 12 for Internet evaluation. This fifth module 12 has a connection with the Internet 13 via a wireless or landline interface 14; the interface 14 in the present embodiment is implemented via a so-called Transmission Control Protocol-Internet Protocol (TCP-IP). For that purpose, however, still other network protocols can be used, such as UDP. The fifth module 12 is embodied for automatically calling up current information from the Internet 13. Via a GPS and compass module 16, a position of the camera 2 is determined and compared with geographical information from the Internet 13. From this, the fifth module 12 derives a model concept of the observed scene and transfers it to the scene model. Thus the scene model in the fourth module 10 is furnished with additional information about nearby structures, such as houses, trees, streets, and the like (curved arrow 15). The scene model is furthermore embodied for connecting such information to an already-learned model. Further information that the fifth module 12 and the scene model jointly generate are current weather conditions, using weather services on the Internet 13; the course of the sun and attendant shade effects for the camera 2, forecasting leaf and branch motions by taking the wind intensity into account, for instance via weather serves on the Internet 13; and likely objects in the observed scene.

The present embodiment of the arrangement of the invention is thus located in the camera 2 and has at least the modules 10, 12, 14 and 16.

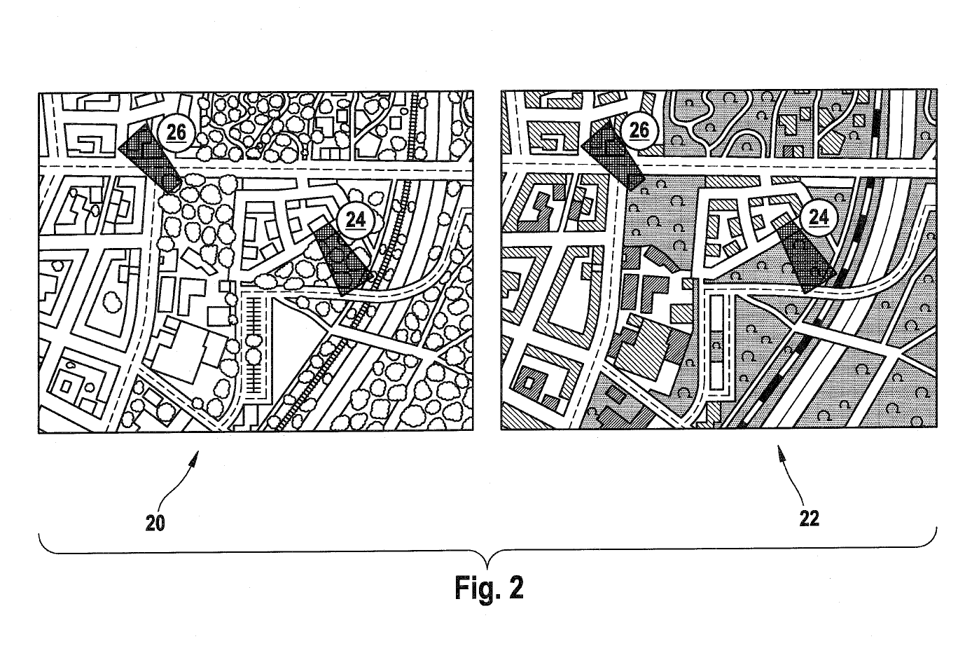

FIG. 2 shows one example for a collaboration of GPS, compass, and geographical data from the Internet. On the left, FIG. 2 shows a schematic aerial view 20 and on the right, it shows a detail from a city map 12 for the city of Duisburg. The two surveillance cameras 24, 26 assumed, and their fields of view, are marked in FIG. 2. Since the geographical data server keeps not only aerial views 20, in this case satellite images, but also city maps 22 in readiness, the cameras 24, 26 can be plotted in both images, once the cameras 24, 26 have reported their respective positions via GPS and compass. Particularly from the city map, it then easily beascertained automatically that the first camera 26 is aimed at an intersection scene, and the second camera 24 is aimed predominantly at a wooded area. From this, suitable modes for the two cameras 24, 26 can be ascertained automatically.

The surveillance unit or arrangement for operating at least one camera need not necessarily be integrated in a housing of the camera 2 as shown in FIG. 1. A spatially separate location of the individual modules is also conceivable.

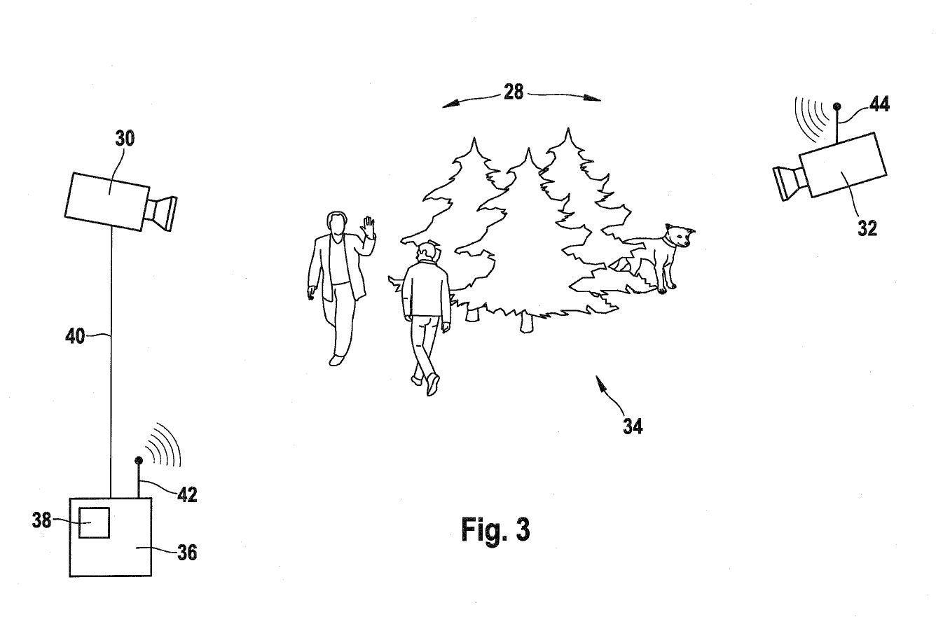

One example for a camera assembly with an embodiment of an arrangement 36 according to the invention is shown in FIG. 3. Here a camera assembly 28 includes a first camera 30 and a second camera 32, which are embodied for observing a scene 34. The camera assembly 28 furthermore includes the arrangement 36 with the at least one module 38 that is intended for determining the position of each of the cameras 30, 32. The cameras 30, 32 are furnished, for common, synergistic image processing, with information from the arrangement 36 about the scene 34 to be observed from each respective position.

Communication for exchanging information takes place between the first camera 30 and the arrangement 36 via a line 40. The arrangement 36 furthermore has an antenna 42, with which the arrangement 36 communicates wirelessly with the second camera 32, which also has an antenna 44. The arrangement 36 in this embodiment furthermore, via the antenna 42, establishes a suitable connection with the Internet for furnishing information about the scene 34.

1. A method for operating at least one camera (2, 30, 32), in which a position of the at least one camera (2, 30, 32) is determined, and for image processing, information about a scene (34) to be observed from that position is furnished.

2. The method as defined by claim 1, in which the information is furnished from the Internet (13).

3. The method as defined by claim 2, in which pages from the Internet (13) are evaluated.

4. The method as defined by claim 1, in which the likelihood with which objects, and which ones of those objects, are to be observed by the camera (2, 30, 32) in the scene (34) is taken into account.

5. The method as defined by claim 1, in which weather prevailing in the scene (34) to be observed is taken into account.

6. The method as defined by claim 1, in which the at least one camera (2, 30, 32) is registered inside a camera assembly (28) that includes a plurality of cameras (2, 30, 32).

7. The method as defined by claim 1, in which a scene model of the scene (34) to be observed is furnished.

8. An arrangement for a camera assembly (28) having at least one camera (2, 30, 32), wherein the arrangement (36) has at least one module (10, 12, 14, 16, 38) and is embodied for determining a position of the at least one camera (2, 30, 32) and furnishing information about a scene (34) to be observed from that position.

9. The arrangement as defined by claim 8, in which the at least one module (10, 12, 14, 16, 38) is embodied as a GPS receiver.

10. The arrangement as defined by claim 8, in which the at least one module (10, 12, 14, 16, 38) is embodied as an electronic compass.

11. A camera assembly, which has at least one camera (2, 30, 32) and at least one module (10, 12, 14, 16, 38), wherein the at least one module (10, 12, 14, 16, 38) is embodied for ascertaining a position of the at least one camera (2, 30, 32) and furnishing information about a scene (34) to be observed from that position.

12. A computer program having program code means, for performing all the steps of a method as defined by claim 1, when the computer program is executed on a computer or a corresponding computation unit.

13. A computer program product having program code means that are stored in memory on a computer-readable data carrier, for performing all the steps of the method as defined by claim 1, when the computer program is executed on a computer or a corresponding computation unit.
